(19) United States
(12) Patent Application Publication
(10) Pub. No.: US 2004/0221012 A1
(43) Pub. Date: Nov. 4, 2004

(54) E-mail forward filter

(75) Inventor: Roland Heumesser, Oberndorf (DE)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/426,060

(22) Filed: Apr. 30, 2003

(51) Int. Cl. G06F 15/16

(52) U.S. Cl. 709/206; 709/203

(57) ABSTRACT

A method of forward filtering an email received by an email user agent and originally sent to one or more original recipients. The method is performed by the user agent in response to a user input to forward the email to at least one forward recipient. The forward recipient are compared with the original recipient. If it is detected that the forward recipient matches one of the original recipients, the agent causes the e-mail not to be forwarded to the matching forward recipient.

### FIELD OF THE INVENTION

The present invention relates generally to an electronic mail (e-mail) forward filter, and, for example, to a method, a computer, a computer program product and a plug-in for e-mail forward filtering.

### BACKGROUND OF THE INVENTION

Electronic mail has been around for over two decades and grew exponentially during the 1990s to the point at which today the number of e-mails sent per day far exceeds the number of paper letters.

The first e-mail systems were based on simple file transfer protocols with the convention that the first line of each message contained the recipient's address. These systems offered only few functions to the user. To overcome these limitations, more elaborate e-mail systems were proposed resulting in the development of a standard for Internet text messages RFC 822 (“Request for Comments”) by ARPANET in 1982 defining the message format. Apart from minor revisions, today's Internet e-mail is still based on RFC 822. The RFC 822 Internet e-mail standard is published for example on the website www.facqs.org/rfcs/rfc822.html. A general introduction into “e-mail” can, for example, be found in Andrew S. Tanenbaum; Computer Networks, 4^{th} edition 2003, Pearson Education International, pp. 588-611.

Two very popular functions of this standard were (i) the capability of sending a message to a group of people; and (ii) forwarding a message by including it in the body of another message while the forwarded part was identified, e.g. by separating it from the rest of the message. E-mail user agents enable a user to write, send and manage e-mails, usually via a graphical user interface (GUI). Today, comfortable e-mail user agents provide user friendly functions to forward an e-mail or to reply to one or more recipients. Further, address books are typically offered in order to provide a convenient way to specify the addresses of the recipients and to create and handle mailing lists. These lists may contain a number of recipients as a group, such as “all colleagues of department X” or “all members of project Y”, which can be easily accessed by a single alias name when the user wants to send or forward an e-mail to all members of a specific mailing list without the need to type or specify each recipient individually.

Besides being a convenient way to send messages around the world, there are a number of other factors that have contributed to the enormous popularity of e-mail compared to paper letters: it is less expensive, very informal, has a low threshold of use, and it is delivered almost instantaneously to any corner of the world.

However, the popularity of e-mail also has its drawbacks: people are often overwhelmed with e-mails, not least due to the widespread use of mailing lists. For example, an employee of a large international company may be included in many local or company-wide mailing lists, such as mailing lists for various projects, functions or interests within the company. As consequence, the employee may receive the same e-mail twice or even more often.

JP 2001024692 A describes an e-mail transmission system which does not transmit e-mails with the same content to a recipient more than once.

### SUMMARY OF THE INVENTION

A first aspect of the invention is directed to a method of forward filtering an email received by an email user agent and originally sent to one or more original recipients. According to the first aspect, the method is performed by the user agent in response to a user input to forward the email to at least one forward recipient, and comprises the steps of: (i) comparing the forward recipient with the original recipients; and (ii) if it is detected that the forward recipient matches one of the original recipients, the agent causing the original e-mail not to be forwarded to the matching forward recipient.

According to another aspect, a further method is provided of forward filtering an email received by an email user agent and originally sent to one or more original recipients. The method is performed by the user agent in response to a user input to forward the email to at least one forward recipient. The method comprises the steps of: (i) comparing the forward recipient with the original recipients; and (ii) if it is detected that the forward recipient matches one of the original recipients, the agent requesting the user to confirm that the original e-mail is not to be forwarded to the matching forward recipient and, according to the user confirmation, causing the original e-mail not to be forwarded to the matching forward recipient.

According to another aspect, a method of e-mail forward filtering performed by an e-mail server is provided. The method is carried out in response to a receipt, from a user, of an e-mail to be sent to recipients of a mailing list. It comprises the steps of: (i) ascertaining whether the e-mail is a forward e-mail including information for identifying the e-mail's original recipients; (ii) comparing the recipients of the mailing list with the original recipients; and (iii) if it is detected that one of the recipients of the mailing list matches one of the original recipients, the e-mail server causing the e-mail not to be sent to the matching recipient.

According to another aspect, a computer is provided comprising a component for receiving and sending e-mails. The e-mail component is arranged to filter a forward e-mail in response to a user input to forward an original e-mail received by the e-mail user agent to at least one forward recipient. The original e-mail was sent to one or more original recipients. The e-mail component is arranged to compare the forward recipient with the original recipients and is arranged, in response to a match between the forward recipient and one of the original recipients, to perform at least one of the following: (a) to request the user to confirm that the original e-mail is not to be forwarded to the matching forward recipient and, according to the user confirmation, to cause the original e-mail not to be forwarded to the matching forward recipient; or (b) to cause the original e-mail not to be forwarded to the matching forward recipient without user confirmation.

According to another aspect, a computer is provided including an e-mail user agent arranged to enable a user to generate a forward e-mail in order to forward an original e-mail received by the e-mail user agent to at least one forward recipient. The original e-mail was sent to one or more original recipients. The e-mail user agent comprises means for filtering the forward e-mail in response to a user input. The means for filtering comprise: (i) means for comparing the forward recipient with the original recipients; and (ii) means for causing the original e-mail not to be forwarded to the matching forward recipient if the comparing means detect that the forward recipient matches one of the original recipients.

According to another aspect, a computer program product is provided including program code for execution on a computer comprising an e-mail user agent for filtering an email received by the agent and originally sent to one or more original recipients. The agent is arranged to, in response to a user input to forward the email to at least one forward recipient, (i) compare the forward recipient with the original recipients; and (ii) cause the e-mail not to be forwarded to the matching forward recipient if the agent detects that the forward recipient matches one of the original recipients.

Another aspect is directed to a plug-in for providing an e-mail user agent with an e-mail forward filter functionality. The e-mail user agent is arranged to enable a user to generate a forward e-mail in order to forward an original e-mail received by the e-mail user agent to at least one forward recipient. The original e-mail was sent to one or more original recipients. When executed, the plug-in (i) compares the forward recipient with the original recipients; and (ii) causes the original e-mail not to be forwarded to the matching forward recipient if the agent detects that the forward recipient matches one of the original recipients.

Other features are inherent in the disclosed method, computer, computer program product and plug-in or will become apparent to those skilled in the art from the following detailed description of embodiments and its accompanying drawings.

### DESCRIPTION OF THE DRAWINGS

Embodiments of the invention will now be described, by way of example, and with reference to the accompanying drawings, in which

FIG. 1 shows a schematic overview of an e-mail user agent;

FIG. 2 is a is a high-level flow chart of a forward filter;

FIG. 3 is a flow chart of a forward filter requiring no user confirmation;

FIG. 4 is a flow chart of a forward filter requiring user confirmation;

FIG. 5 is a flow chart of another embodiment, analogous to FIG. 4, in which sets of matching and non-matching forward recipients are determined and separately processed;

FIG. 6 is a flow chart of a forward filter differentiating between amended and unamended forward e-mails;

FIG. 7 is a flow chart of a forward filter similar to FIG. 6 which requires user confirmation in the processing of unamended forward e-mails;

FIG. 8 is a flow chart of a forward filter similar to FIG. 6 which requires user confirmation in the processing of amended forward e-mails;

FIGS. 9 and 10 are flow charts illustrating two alternative embodiments which differ in terms of the time when the filter process is performed;

FIG. 11 illustrates a forward filter implemented as a plug-in;

FIG. 12 illustrates a forward filter integrated within an e-mail user agent;

FIG. 13 is a diagrammatic representation of a computer including an e-mail user agent;

FIG. 14 illustrates forward filter processing carried out by an e-mail server.

Throughout the drawings, corresponding steps and components bear the same reference signs.

### DESCRIPTION OF PREFERRED EMBODIMENTS

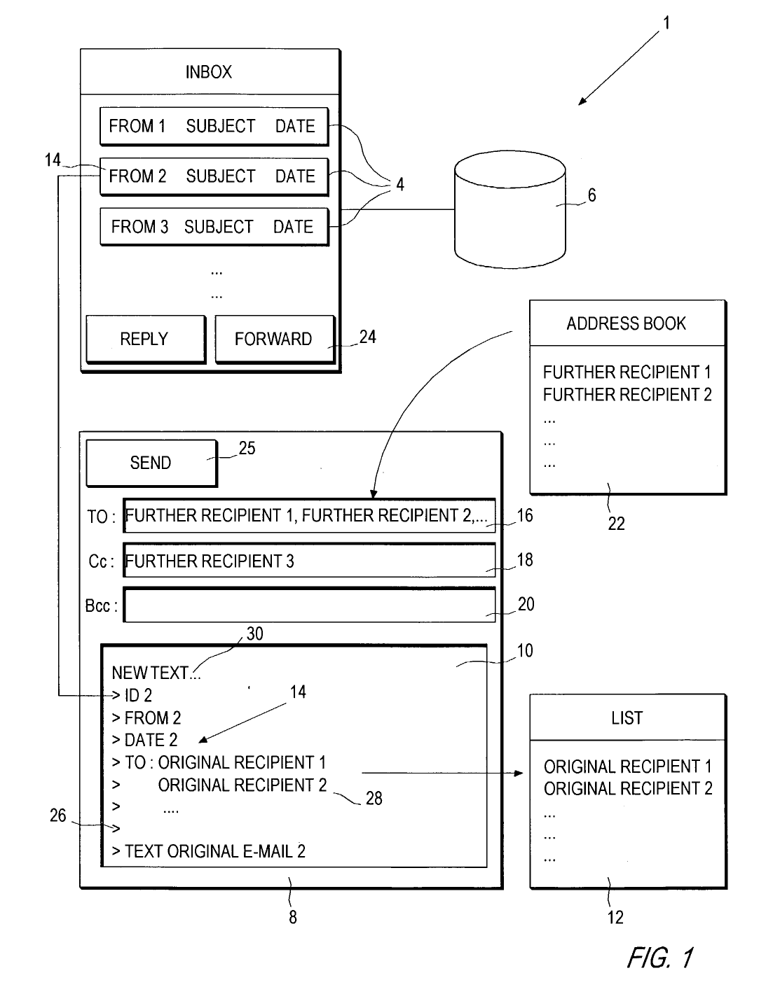

FIG. 1 shows components of an e-mail user agent. Before proceeding further with the detailed description of these components, however, a few items of the embodiments will be discussed.

E-mail systems have generally two basic parts: user agents which enable users to read, send and manage e-mails, and the message transfer agents which move the e-mail messages from the source to the destination. The message transfer agents are typically system demons, i.e. processes that run in the background without interacting with the user and that are responsible for establishing a connection to the destination, transferring the e-mail messages and releasing the connection. The e-mail user agents (also called “e-mail clients”) are programs that provide a command-based, menu-based and/or graphical interface for interacting with the e-mail system, e.g. for composing, receiving, and replying to messages as well as for manipulating mailboxes, in which the received e-mails are stored, and maintaining mailing lists, which are lists of individual e-mail addresses. Examples of e-mail user agents are the Microsoft program Outlook or Netscape's Messenger program.

There are two widely used final-delivery protocols for e-mail: POP3 (Post Office Protocol Version 3) and IMAP (Internet Message Access Protocol). Using POP3, when the user starts the mail reader (which is that part of the user agent arranged to read e-mails), normally all messages in the user's mailbox at the transfer agent are downloaded, stored on the user's hard disk, and the mailbox is emptied. When using IMAP, the messages will remain on a mail server permanently in the user's mailbox (or mailboxes). E-mails are downloaded for the purpose of reading them, but it will not be permanently stored on a user's storage. Many available user agents can be configured to work with POP3 or IMAP, and the described embodiments also work with both POP3 and IMAP (as to POP3 and IMAP, see Tanenbaum, pp. 605-609).

Usually e-mail user agents also offer the functionality of an address book in which e-mail addresses can be stored and later referred to e.g. by the e-mail address, by the name or forename, by an alias name such as a nick-name, by the initials of a person or other abbreviations, etc. The entries of such an address book can then be sorted and, in particular, organized in mailing lists, in which a number of e-mail addresses can be accessed by one single name.

An e-mail user agent further comprises a number of mailboxes in which, for example, received e-mails and copies of sent e-mails are stored (POP3) or a mechanism to read e-mails stored in such mailboxes on a mail server (IMAP), and in particular, a so-called inbox in which the newly arrived e-mails are stored and displayed.

When a user wants to forward an e-mail from the inbox or other mailboxes to a further recipient from the address book or another further recipient (not from the address book), the user selects interactively the corresponding e-mail and activates the process of forwarding an e-mail, e.g. by selecting the corresponding forward button of the graphical user interface of the e-mail user agent. Either before or after activating the process of forwarding an e-mail, the user needs to specify to which further recipient or further recipients the e-mail should be forwarded. Therefore, the user agent provides with which the user can specify the corresponding e-mail addresses either by typing the address manually or by choosing the addresses from the address book. In some embodiments, the user is able, when the e-mail is forwarded to several further recipients, to differentiate between primary recipients, which are referred to as “To” in the user interface, and secondary recipients, which are referred to as “Cc” (“carbon copy”). However, the e-mail is forwarded to both primary and secondary recipients regardless of the attributes “To” or “Cc”. In some embodiments, the attribute “Bcc” (“blind carbon copy”) can be additionally assigned to a further recipient. This attribute causes the e-mail to be forwarded also to the “Bcc”-recipients, however, these recipients do not appear in the copies sent to the primary and secondary recipients. This feature allows people to send copies to third parties without the primary and secondary recipients knowing this.

The term original e-mail refers to the e-mail chosen by the user from one of the mailboxes in order to be forwarded to one or several further recipients.

In some embodiments, when the process of forwarding an e-mail is activated by the user, a text box containing the original e-mail is displayed on the computer screen in which the user can add content (e.g. text) to be sent in addition to the original e-mail or amend, for example, the reference line or the content (e.g. the text) of the original e-mail.

The term e-mail refers generally to electronic messages that are sent between computers over the Internet. However, the embodiments are not limited to classic Internet e-mail but also comprise company internal e-mails or other kinds of electronic messages within an internal network such as internal notes, or any other kind of electronic messages that are transferred via a network. The mail transfer is not limited to computer networks but may also include other communication networks such as mobile telecommunication networks. In this context, the term e-mail may also refer to SMS-like (short message service) and MMS-like (multimedia message service) messages that are exchanged between telephones, portable computers and mobile telephones over a telecommunication network.

According to the RFC 822 standard, e-mails are composed of an envelope and a message. The envelope encapsulates the message. It contains all the information needed for transporting the message such as the destination address, priority and security level, all of which are distinct from the message itself. The message itself consists of a header and a message body which is separated from the header fields by a blank line. While the header contains control information for the e-mail user agent, the body holds the actual information for the human recipient. Some of the header fields are used by the message transfer agent to compose the envelope.

Besides a unique identifier (message ID), which is a unique number for referencing to the message later, the header comprises a “To” field, a “Cc” field and a “Bcc” field as described above. Other header fields are a “From” field, which specifies who wrote the message, or a “Subject” field.

When an original e-mail is forwarded, additional fields are added to the original header fields. These new header fields are identified by the prefix “Resent” and are followed by one of the standard fields, e.g. “Resent-From”, “Resent-Date”, “Resent-To”, “Resent-Cc” or “Resent-Message-ID”, etc. For example, the “Resent-From” field indicates the person that created the forward message, whereas the “From” field indicates the person that created the original message. When forwarding an e-mail, the further recipients are contained in the “Resent-To” or “Resent-Cc” fields while the original recipients are included in the “To” or “Cc” fields.

Each header field consists of a single line of ASCII text containing the field name, a colon and for most fields, a value. Thus, a header field has the following syntax:

Field name: [field-body] CRLF The field name is used to identify the specific field when parsing through the header. The field name is separated from the field body by a colon. The field body contains the value of the field, e.g. the e-mail addresses of the recipients, the date or the message ID. As each field consists of one line of ASCII text, it is terminated by a carriage return and line feed. (CRLF).

In order to access the original recipients of an e-mail to be forwarded, in some embodiments a parser parses the e-mail to be forwarded. Such a parser searches through the header fields e.g. for the field “To”. When it detects this field, it reads in the data of the field containing, in this case, the original primary recipient or recipients. Similar processing is performed, in some of the embodiments, in order to retrieve the further recipient or recipients of the e-mail to be forwarded. In this case, the parser searches e.g. for the “Resent-To” field of the e-mail to be forwarded. In other embodiments, however, the further recipients are directly extracted from the user interface when the user specifies the e-mail addresses or names of the further recipient or recipients, i.e. the further recipients are directly read out from the “To” mask of the e-mail user agent.

In some of the embodiments, forward e-mails are prevented from being forwarded to “matching forward recipients” without requiring user confirmation. The forward recipient is compared with the original recipients and if it is detected that it matches one of the original recipients, the agent causes the original e-mail not to be forwarded to the matching forward recipient, without requiring user confirmation therefor.

In other embodiments, the agent requests the user to confirm that the original e-mail is not to be forwarded to the matching forward recipient, and, if the user confirms, the agent causes the original e-mail not to be forwarded to the matching forward recipient. This means that the user has the possibility to intervene by confirming or not confirming that the e-mail is not to be forwarded to the matching recipient.

This forward filter functionality is also useful when mailing lists are used. Often a user included in such a list receives an e-mail sent to the members of the original mailing list and wants to forward it to the members of another mailing list (called “forward mailing list”). However, the forward mailing list may overlap with the original mailing list. As a consequence, a number of original recipients would receive this e-mail twice. This would be bothersome for these (i.e. the “matching”) recipients.

In order to avoid this situation when more than one forward recipient is specified (e.g. by a forward mailing list), the user can be requested, either individually for each matching recipient or collectively for all matching recipients, to confirm that the e-mail is not to be forwarded to the matching forward recipient(s).

It may happen that the user amends the original e-mail to be forwarded. He or she may, for instance, change the content of the original e-mail or add additional content. When the user adds text, a comment for example, to the original e-mail, this text usually appears separated from the text of the original e-mail in the display of the e-mail user agent so that the further recipient can distinguish between the original text of the original e-mail and the newly added text. However, the user may also amend the text of the original e-mail, for example enter comments directly into the original text.

When the original e-mail has been amended, the user may wish to forward this amended e-mail even to those original recipients that have already received the original e-mail. Therefore, in some embodiments, the agent causes the original e-mail to be forwarded to a forward recipient, even if it is a matching forward recipient, without requiring user confirmation. On the other hand, if the original e-mail has not been amended by the user, the agent prevents the original e-mail from being forwarded to the matching forward recipient, in some embodiments without requiring user confirmation therefor, in other embodiments only if the user confirms that the e-mail is not to be forwarded to the matching recipient. If no user confirmation is required, either for amended or for unamended e-mails, the filter process is automatic, without user interaction.

In other embodiments, a stronger filter is implemented in the sense that, if the original e-mail is amended by the user it is not unconditionally forwarded, but the user is asked for a confirmation that the (amended) e-mail ought not to be forwarded to matching forward recipients. This might for instance be useful if the user wants to differentiate between cases with minor amendments not relevant for the matching recipients and cases with relevant amendments in which the amended e-mail is also to be forwarded to the matching forward recipients. If the original e-mail has not been amended by the user, the agent prevents it from being forwarded to the matching forward recipient, without requiring user confirmation.

In other embodiments, no differentiation is made between amended and unamended forward e-mails, i.e. both amended and unamended e-mails are prevented from being forwarded to matching forward recipients, either with or without requiring user confirmation therefor.

If the user has specified more than one forward recipient, and more than one of the forward recipients matches the original recipients, the user is, in some of the embodiments, requested to confirm that the original e-mail is not to be forwarded to the matching forward recipients. As already mentioned above, in one embodiment, the user confirmation is requested individually for each matching forward recipient, in another embodiment it is requested only once for all matching forward recipients. In the first case, the user can individually decide to which matching forward recipient the original e-mail ought to be forwarded, which can be useful, in particular, when the original e-mail has been amended by the user. In the second case, the user is not bothered by repeated requests, but can provide an overall confirmation, e.g. by a single mouse-click.

In some embodiments, the recipients are identified by their e-mail address, in other embodiments by their name, in other embodiments both identification methods are combined. Some e-mail systems not only transmit the sender's e-mail address but also his or her full name or alias name. Sometimes it is also possible to extract a recipient's name from his or her e-mail address, as addresses are often composed, e.g. in the form forename.name@domain. To find matching recipients, not only the e-mail addresses of the forward recipients and the original recipients are compared, but also their names, if they are available. The names of the further recipients can, for example, be extracted from the address book in which an e-mail address is associated with the real name of the person or some alias name. This can be useful, in particular, if a recipient has several e-mail addresses, such as a private e-mail address and a company e-mail address, or special e-mail addresses for specific projects. In those cases, the result of the comparison process is independent of the specific e-mail address used by the original recipients or the forward recipients, as the matching recipients are identified by their names.

In addition, in some embodiments not only identical e-mail addresses are compared but also e-mail addresses that are similar are taken into account to find matching recipients. A number of criteria may be defined for which the e-mail address of an original recipient and of a forward recipient are considered to match. For example, a forward recipient and an original recipient can be considered to match if their domain is identical and at least one of the forenames and the name occurring in the respective e-mail addresses coincide. This may be useful as some e-mail providers allow different e-mail addresses to be used for the same e-mail account or person, such as forename@domain, name@domain, forename.name@domain, etc.

The process of filtering described above may be performed at various times during the forward process.

In some embodiments the filtering is already performed when the user specifies one or more forward recipients using the corresponding interface of the e-mail user agent, i.e. for example when typing the e-mail address or the name of the forward recipient or recipients or a forward mailing list or selecting the forward recipient or mailing list from the address book. Then the filter process starts. If more than one forward recipient is specified, the filtering is started either after the specification of one forward recipient has been completed individually for this recipient or after all forward recipients have been specified. In the latter case, the filtering is triggered when the user switches from the interface of the e-mail user agent for specifying the forward recipients, e.g. the “To” field, to another part of the e-mail user agent. Alternatively, the filtering might be performed continuously by a demon program which runs in the background and checks continuously or in predefined time intervals the forward recipients of the e-mail to be forwarded e.g. by reading out the corresponding user interface or parsing through the e-mail to be forwarded.

In other embodiments the filter process is only performed when the user commands the e-mail user agent to actually dispatch the forward e-mail. For example, the filtering is triggered when the user pushes the send button of the e-mail user agent which causes the e-mail user agent to transfer the forward e-mail to the e-mail transfer agent.

Sometimes e-mails are successively forwarded several times from one recipient to another and so forth. In this way, chains of forwarded e-mails may be produced while for each step a number of recipients is specified. There will be not only one set but several sets of original recipients from previous forward processes before the e-mail is sent to the user. In some embodiments the forward recipient specified by the user is compared with all or at least some of the recipients to whom the original e-mail was previously sent or forwarded.

Typically, an e-mail user agent enables the user to specify attributes for forward recipients, such as “To” or “Cc”. In some embodiments, only the forward recipients with a specific attribute are compared with the original recipients, e.g. only the forward recipients from the “Cc” field are included in the filtering process, while the forward recipients from the “To” field are not subject to the filtering. In these embodiments, it is assumed that the user associates a more important role to forward recipients of the “To” field and thus does not want them to be included in the filtering.

Some embodiments of the computer program product and the plug-in comprise program code which, for example, is stored on a computer-readable data carrier or is in the form of signals transmitted over a computer network or the Internet. Some embodiments of the program code and the plug-in are written in an object-oriented programming language (e.g. Java or C++). The program code can be loaded (if needed after compilation and linking with other code) and executed in a digital computer such as a personal computer.

In some embodiments, mailing lists are not locally stored on the user's computer, but rather centrally, e.g. on an e-mail server accessible by many users over a network. Usually, a particular e-mail address is assigned to such a centrally stored mailing list, and the user can send an e-mail to all the addresses included in the mailing list by sending it to the mailing list's address. The e-mail server then sends this e-mail to the addresses in the mailing list.

In some of the embodiments with centrally stored mailing lists, the user agent retrieves the mailing list from the mailing server when an e-mail is to be forwarded to a centrally stored mailing list. The forward-filter processing is then carried out locally at the user agent, as if the mailing list were locally stored.

In other embodiments with centrally stored mailing lists, the forward-filter processing is performed by the central-mail server when it receives an e-mail from the user which is to be sent to recipients on a mailing list. The e-mail server then ascertains whether the e-mail is a forward e-mail including information about the e-mail's original recipients. If it is such a forward e-mail, the e-mail server compares the recipients on the mailing list with the original recipients. If the e-mail server detects that one of the recipients on the mailing list matches one of the original recipients, it causes the e-mail not to be sent to the matching recipient, analogously to what has been described above. In order to inform the user about this filter action, in some of the embodiments the e-mail server returns a message to the user indicating that the e-mail was not sent to the matching recipient.

Returning now to FIG. 1, components of an e-mail user agent and a user interface for forwarding an original e-mail are shown. Incoming e-mails 4 (i.e. original e-mails) are displayed in an inbox window 2. In the inbox window 2, attributes of the incoming e-mails 4, such as the sender, the date, the priority, a reference line, an icon indicating whether there are files attached to the e-mail, the first phrase of the text of the e-mail, etc., are displayed usually in form of a list of incoming e-mails 4. The e-mail user agent enables the user to define the attributes to be displayed and the way in which the incoming e-mails 4 are sorted in the inbox window 2, e.g. chronologically by date. Internally, all e-mails are stored in a data base 6, which is usually one or more files in which all e-mails are stored on the user agent's computer or a remote mail server. Every e-mail in the storage file 6 is referenced by a unique identifier ID. Various file types may be used according to the specific e-mail user agent used. For example, the Microsoft Outlook e-mail user client uses a pst-file which is updated when new e-mails are received.

When a particular original e-mail 14 from the list of incoming e-mails 4 in the inbox 2 is selected by the user by activating a forward button 24, e.g. with a computer mouse, the e-mail user agent opens a forward e-mail 8 in a user interface window in which the selected original e-mail 14 is displayed.

The original e-mail 14 is displayed in a text box interface 10 of the forward e-mail 8, wherein it is visually distinguished from the other text of the text box interface 10 by a special character 26 (e.g. “>”) which marks every new line of the original e-mail. In other embodiments, the original e-mail is marked by indenting its text in the text box interface 10. Not only the text of the original e-mail is displayed but also some header fields, such as the ID, a “From” field, a “Date” field, and a field or fields 28 containing the original recipients. The latter are the “To” or “Cc” fields of the original e-mail. The user can then add additional text 30 in the text box interface 10 of the forward e-mail 8. User input masks 16, 18 and 20 are provided in order to specify the recipient or recipients to whom the forward e-mail is to be forwarded. These masks are related to the “To” field, “Cc” field and “Bcc” field of the forward e-mail. The user can specify the forward recipients by typing their e-mail addresses, their names or alias names associated with the e-mail address, by keyboard input or by selecting them from an address book 22, e.g. using the computer mouse or keyboard shortcuts. The user can likewise specify forward recipients by selecting a mailing list. If the selected mailing list is centrally stored, e.g. on an e-mail server, it is retrieved from it by the user agent.

Some embodiments extract from the original e-mail 14, and in particular from the “To” and “Cc” fields of the original e-mail, a list 12 containing the original recipients by parsing through the original e-mail 14.

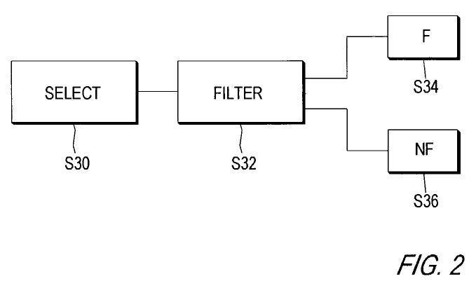

As illustrated in FIG. 2, the user generally selects in step S30 an original e-mail from one of his mailboxes, e.g. by using the computer mouse or the keyboard, and activates the forwarding process e.g. by pushing the forward button 24 of the user e-mail agent. A forward e-mail 8 is created and submitted to a filtering process S32. Depending on the result of the filtering S32, the original e-mail is actually forwarded (f, S34) or (actually) not forwarded (nf, S36).

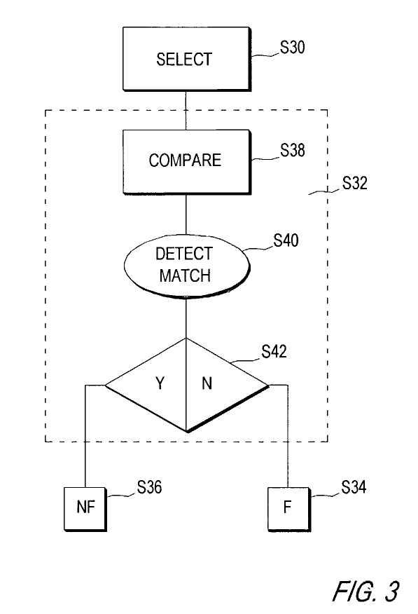

In the embodiments according to FIG. 3, the filtering process S32 comprises step S38 of comparing the forward recipients which are specified by the user with the original recipients. In step S40, and as result of the comparison S38, those forward recipients are detected and identified which match one or several original recipients. If one or more matching forward recipients are detected (Y in step S42) the e-mail is automatically not forwarded according to step S36, i.e. without requiring user confirmation. Although the user is not requested to confirm that the original e-mail is not to be forwarded in some embodiments, a notification is output that the original e-mail has not been forwarded to the matching forward recipients. Otherwise, if no matching recipients are detected (N in step S42), the original e-mail is regularly forwarded to the specified forward recipients according to step S34.

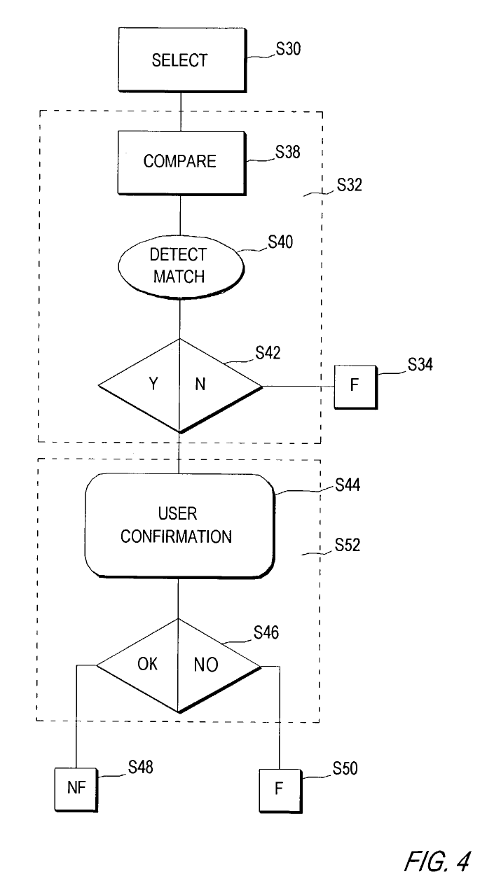

In other embodiments according to FIG. 4, the original e-mail is regularly forwarded in step S34, as in the embodiment depicted in FIG. 3, if the steps S38, S40 and S42 of the filtering process S32 do not detect any matching forward recipients. However, if one or more forward matching recipients are detected (Y in step S42) the user is required in step S44 to confirm that the original e-mail ought not to be forwarded to the matching forward recipients. When the user confirms in step S46, the original e-mail is not forwarded to the matching forward recipients according to step S48. Otherwise, if the user refuses the confirmation (N in step S46) the original e-mail is forwarded in step S50 to the forward recipients even though one or more forward recipients are identical with the original recipients.

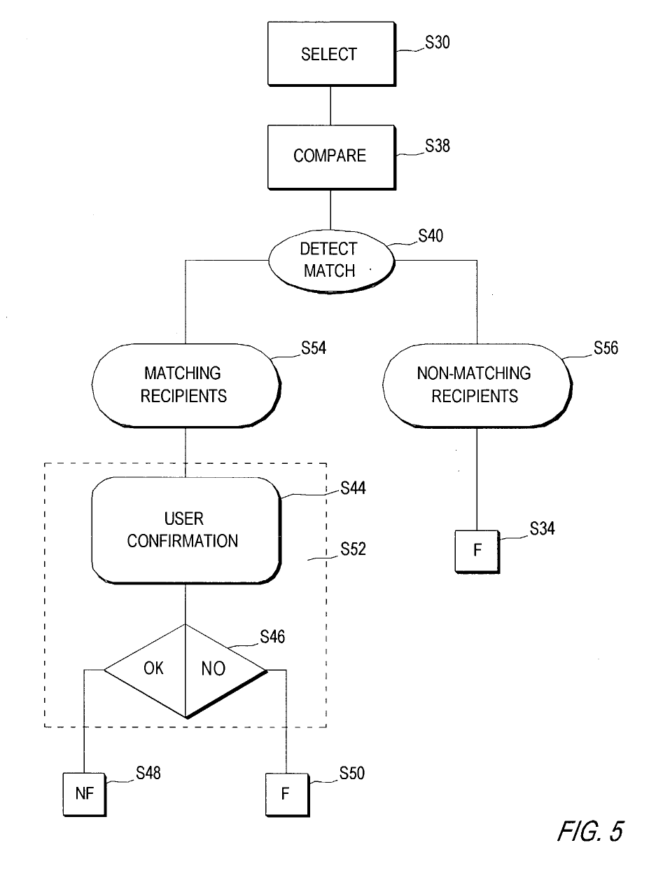

If more than one forward recipient is specified, in some embodiments the filtering process, examples of which are shown in FIGS. 3 and 4, is subsequently carried out all forward recipients. In other embodiments, an example of which is shown in FIG. 5, in a first phase only the steps of comparing (S38) and match detecting (S40) are subsequently carried out for all forward recipients. As a result of this first phase, two sets of forward recipients are found, matching recipients (denoted by S54) and non-matching recipients (denoted by S56). In a second phase, the elements of the sets of matching and non-matching recipients are separately processed. For the elements of the set of non-matching recipients the forward e-mail is forwarded (S34). For the elements of the set of non-matching recipients, in the example of FIG. 5, the user is requested to confirm in step S52 that the original e-mail ought not to be forwarded to the matching recipients. Only if the user confirms in step S46 the confirmation request of step S44, the original e-mail is not forwarded to those forward recipients (step S48). Otherwise, i.e. if the user refuses the confirmation (N in step S46), the original e-mail is finally also forwarded to the matching forward recipients (step S50).

A function of the user confirmation is to warn and inform the user that one or more of the further recipients has already received the original e-mail. The confirmation request can be implemented as a warning pop-up displayed in the e-mail user agent and allowing the user at least two possibilities to answer, such as YES/NO. An example of such a pop-up display is:

WARNING:

The recipient you want to forward this e-mail to has already received it. Do you really want to forward it to this recipient?

[YES] [NO]

The user can then decide on one of the possibilities by clicking with the mouse on the YES or NO button.

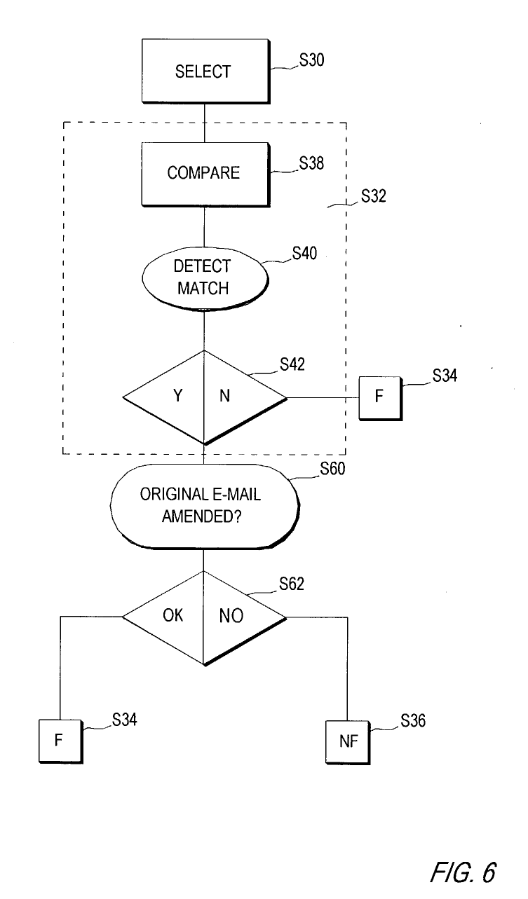

FIGS. 6, 7 and 8 illustrate three different types of embodiments for treating the case in which the original e-mail has been amended by the user. All these three types may be implemented in the same user agent, enabling the user to choose between the three alternatives, either when configuring the agent, or individually for each forward process.

There are several ways for the user to amend the content of an original e-mail. The user can amend the original e-mail for example by adding additional text to the text of the original e-mail, by changing or reformatting the text of the original e-mail or by including additional forward recipients that are not already on the list of the original recipients.

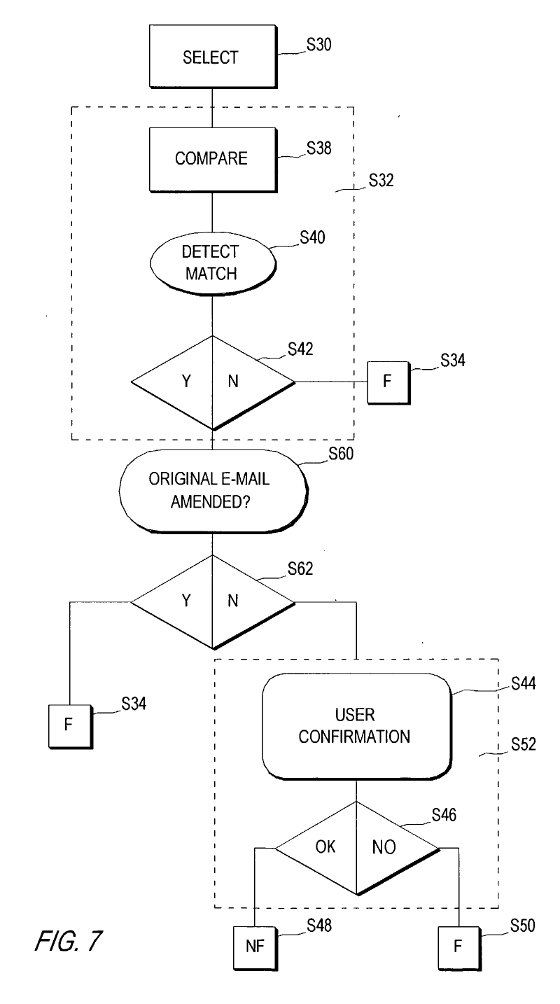

In the embodiments of FIGS. 6 and 7, the filtering step S32 is performed to detect matching forward recipients, and if no matching forward recipients are detected in step S42, the original e-mail is forwarded to the forward recipients in step S34 as described above.

In the embodiments of FIG. 6, if one or more matching forward recipients are detected in step S42, it is determined in step S60 whether the original e-mail has been amended in the above sense, e.g. by comparing the content of the original e-mail with the content of the e-mail to be forwarded. If it is detected in step S62 that the original e-mail has not been amended, the forward e-mail is not forwarded to the matching forward recipients according to step S36. The user is not requested to confirm step S36. On the other hand, if the original e-mail has been amended by the user (Y in step S62), the forward e-mail is forwarded to the matching recipients in step S34, without requesting confirmation therefor.

In the embodiments of FIG. 7, if the original e-mail has been amended it is also forwarded to matching recipients in step S34, without user confirmation, as in FIG. 6. However, if no amendments are detected in step S62, the user is warned that the original e-mail is being sent identically a second time to the matching forward recipients and confirmation is requested in step S52 that the e-mail should not be forwarded

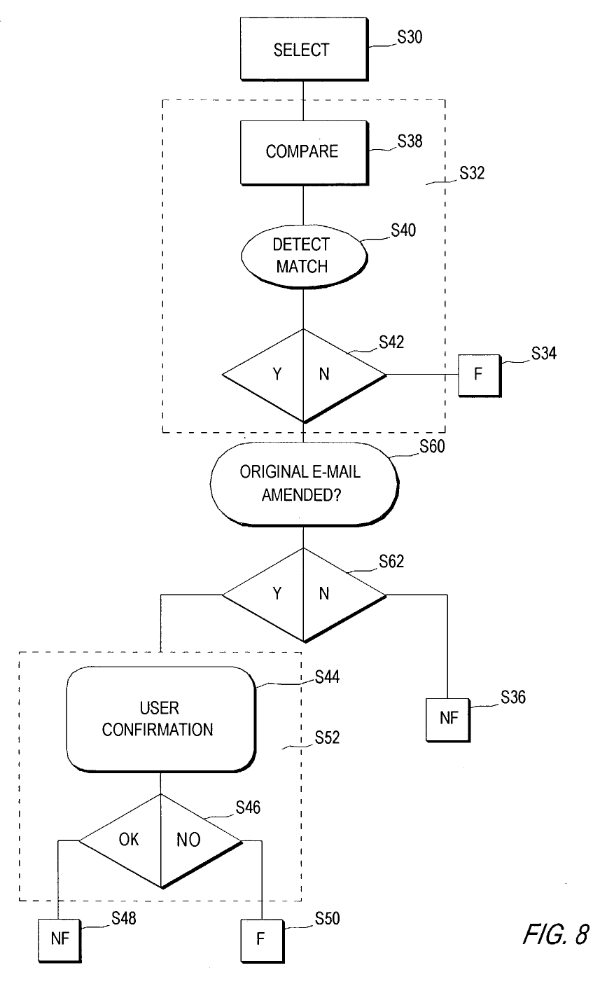

In contrast thereto, in the embodiments of FIG. 8, the original e-mail is automatically not forwarded to the matching forward recipients (i.e. without requiring user confirmation) in step S36 of FIG. 8, unless amendments have been detected in step S62. On the other hand, if amendments have been made to the original e-mail, the user is asked in step S52 to confirm whether the original e-mail ought to be forwarded to the matching forward recipients (step S50) or not (step S48).

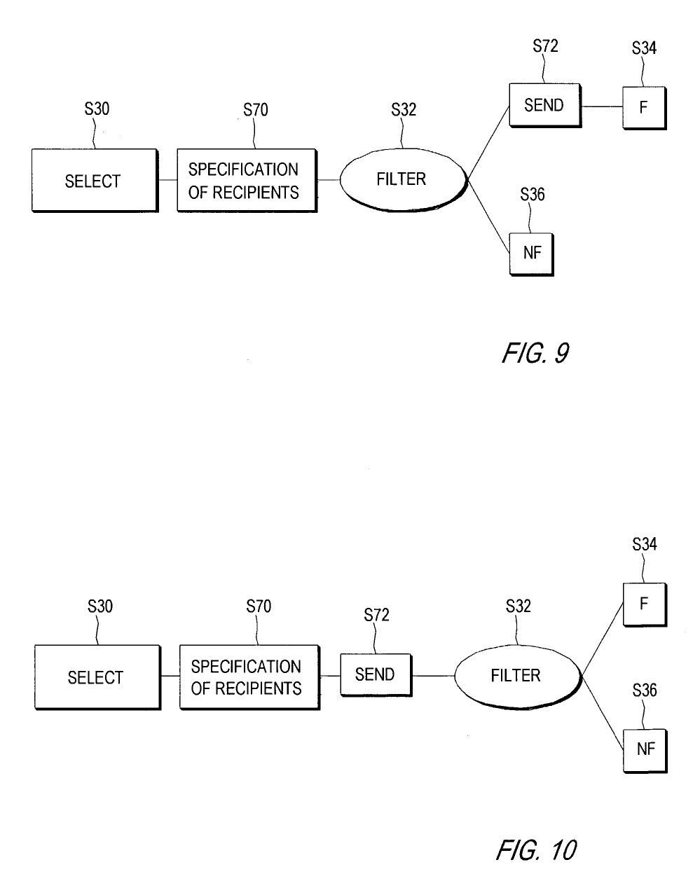

In FIGS. 9 and 10 two alternative embodiments are illustrated which differ in terms of the time when the filter process is performed. In the embodiment of FIG. 9, the filter S32 is applied just after selection of the original e-mail and activation of the forwarding process in step S30 and specification of the forward recipients in step S70. This means that, depending on the result of the filtering S32, the process of forwarding the e-mail to matching recipients is interrupted according to step S36 already after the input of the forward recipients in step S70 by the user. If the filter is not applied, for example if no matching forward recipients are detected, the original e-mail is forwarded according to step S34 when the user actually commands the e-mail user agent to dispatch the original e-mail e.g. by pushing the send-button 25 of FIG. 1 in step S72.

On the other hand, in the embodiment of FIG. 10, the filter process is not directly carried out after the specification of the forward recipients in step S70, but only when the user commands the e-mail user agent to dispatch the forward the forward e-mail, for example by pushing the send-button 25 (FIG. 1) in step S72. The filtering process S32 is then applied, and according to the filter result, the original e-mail is either forwarded to the matching forward recipients in step S34 or not forwarded in step S36.

In some embodiments, features of several embodiments described above are implemented in combination. In some embodiments the user may choose between the different features when configuring the e-mail user agent, so that it presents a functionality according to the chosen one of the embodiments described above. In other embodiments further criteria are implemented which provide an automatic decision between the different features in a specific situation.

For example, the user may choose between introducing user confirmation before an e-mail is finally prevented from being forwarded, according to FIG. 4, and working without such confirmation requirement, according to FIG. 3. As another example, separate treatment of the matching forward recipients and the forward recipients according to FIG. 5 can be combined with the other embodiments described. In all embodiments described, the user may also choose the time when the filtering process is performed, according to FIGS. 9 and 10. Further, the various possibilities of treating amended forward e-mails of FIGS. 6, 7 and 8 can be optionally included in the other embodiments described.

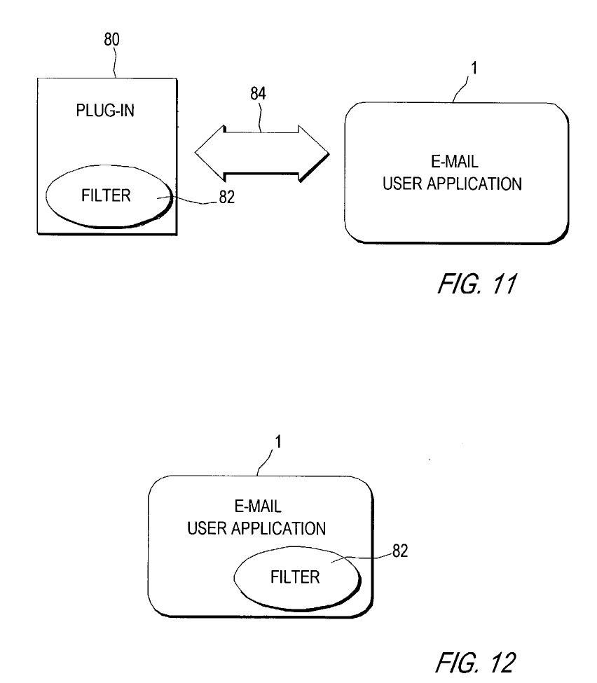

In FIGS. 11 and 12 two different embodiments for implementing a forward filter 82 in an e-mail user agent 1 are illustrated. In the embodiment of FIG. 11, the filter 82 is implemented as a plug-in 80 which can be installed as a component, distinct from the e-mail user agent 1. The plug-in can be downloaded via a network (e.g. Internet) or from a data carrier, such as a CD. This enables the filter 82 to be distributed and sold independently from the e-mail user agent 1. When installed on the same system as the e-mail user agent 1, the plug-in 80 communicates and exchanges data with the e-mail user agent 1 via a common interface 84 which is provided by the e-mail user agent 1. The programming language and the software technology used for implementing the plug-in 80 may be different from the one of the e-mail user agent 1.

In contrast thereto, in the embodiments of FIG. 12, the filter 82 is integrated within the e-mail user agent 1 and communicates and exchanges data via the internal data structure of the e-mail user agent 1. The filter is implemented in the same programming language and it uses the same software technologies as the e-mail user agent 1, as both are usually compiled to one single executable program. The filter 82 is distributed and sold as a part of the e-mail user agent 1.

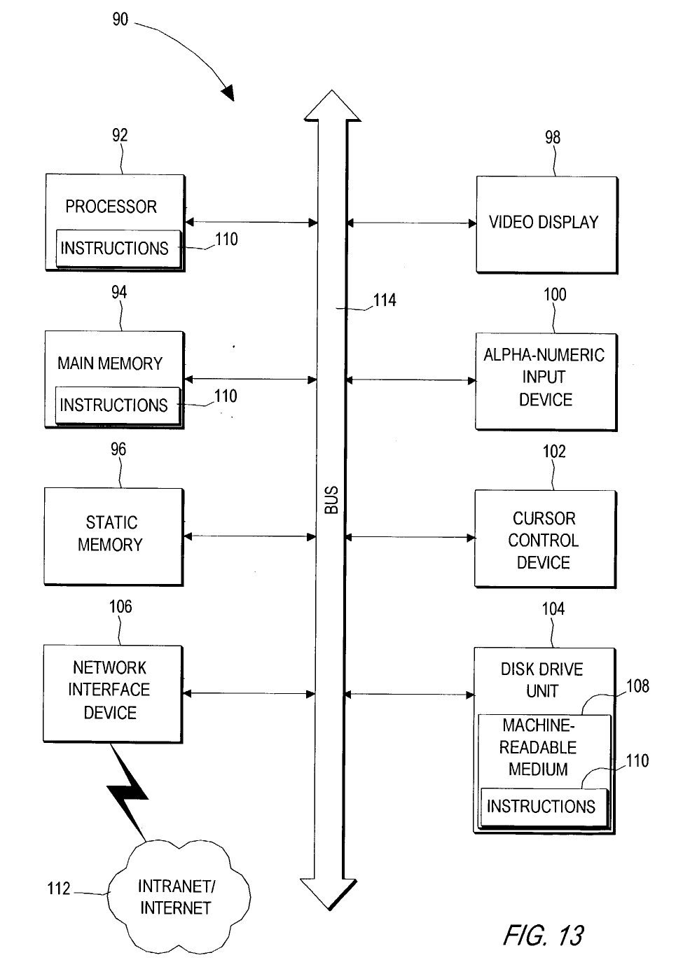

FIG. 13 shows a diagrammatic representation of a computer 90 including an e-mail user agent within which a set of instructions, for causing the e-mail user agent 1 to perform any of the forward filtering methods discussed herein, may be executed. The computer 90 includes a processor 92, a main memory 94 and a network interface device 106, which communicate with each other via a bus 114. It may further include a static memory 96, a video display unit 98, an alpha-numeric input device 100, a cursor control device 102, and a disk drive unit 104. The network interface device 106 connects the computer to an intranet or the Internet 112. The e-mails are received and sent via the network interface device 106. The disk drive unit 104 includes a machine-readable medium 108 on which is stored a set of instructions (i.e. software) 110 embodying any one, or all, of the forward filtering methods described above. The software 110 is also shown to reside, completely, or at least partially, within the main memory 94 and/or within the processor 92. The software 31 may further be transmitted or received via the Internet and through the network interface device 106.

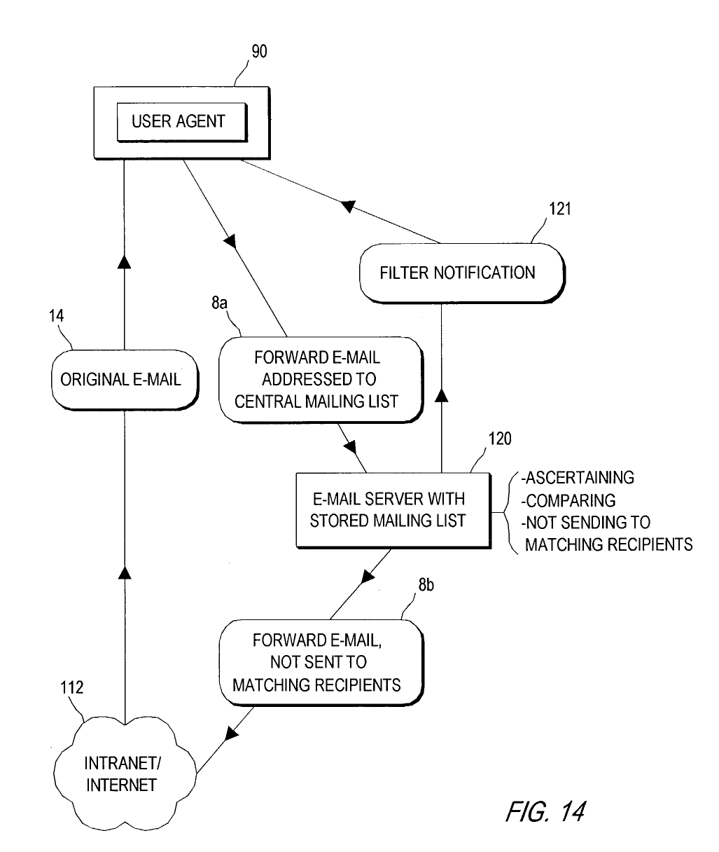

Finally, FIG. 14 illustrates an embodiment in which the filter processing is carried out by an e-mail server 120 to which the computer 90 with the user agent is connected via a network. A forward mailing list is centrally stored on the e-mail server 120. An original e-mail 4 is received at the user agent, and the user forwards this original e-mail to the members of the forward mailing list by merely specifying an address which identifies the centrally stored mailing list. This forward e-mail 8a is sent to the e-mail server 120. The e-mail server 120 then carries out the filter procedure: it ascertains whether the e-mail 8a is a forward e-mail, for example by inspecting “Resent” fields in the e-mail 8a. If the e-mail 8a is found to be a forward e-mail, the e-mail server extracts the e-mail's original recipients and compares them with the original recipients, as described above. In some embodiments, it further ascertains whether the original e-mail has been amended, and prevents an amended e-mail from being filtered, analogously to what has been described above. If the e-mail server 120 detects that one of the recipients of the forward mailing list matches one of the original recipients, it causes the e-mail not to be sent to the matching recipient; i.e. the e-mail (now “8b” in FIG. 14) is only sent to the non-matching recipients. In order to inform the user about this filter action, the e-mail server 120 returns a notification 121 to the user (e.g. in the form of a return e-mail) indicating that the e-mail was not forwarded to all recipients on the mailing list and specifying the matching recipient or recipients to whom it was not forwarded.

Thus, a general purpose of the disclosed embodiments is to provide an improved method, computer, computer program product and plug-in for filtering a forward e-mail, which can prevent the same e-mail from being sent or forwarded to a recipient twice.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A method of forward filtering an email received by an email user agent and originally sent to one or more original recipients, the method being performed by the user agent in response to a user input to forward the email to at least one forward recipient, and comprising the steps of:
(i) comparing the forward recipient with the original recipients; and
(ii) if it is detected that the forward recipient matches one of the original recipients, the agent causing the e-mail not to be forwarded to the matching forward recipient.

2. The method of claim 1, wherein, in step (ii), the agent causes the e-mail not to be forwarded to the matching forward recipient without requiring user confirmation.

3. The method of claim 1, wherein, if the e-mail is to be forwarded to more than one forward recipient, steps (i) and (ii) are carried out for each of the forward recipients, and the e-mail is forwarded to the non-matching forward recipients.

4. The method of claim 1, wherein the e-mail can be amended by the user and wherein amending comprises at least one of (i) changing the content of the original e-mail, and (ii) adding content.

5. The method of claim 1, wherein step (ii) is only executed, if the e-mail has not been amended by the user, but otherwise, the following step is executed instead of step (ii), if it is detected that the forward recipient matches one of the original recipients, requesting the user to confirm that the e-mail is not to be forwarded to the matching forward recipient and, according to the user confirmation, causing the e-mail not to be forwarded to the matching forward recipient.

6. The method of claim 1, wherein, if the e-mail has been amended by the user, the agent causes the e-mail to be forwarded to the forward recipient, even if it is a matching forward recipient, without requiring user confirmation therefor.

7. The method of claim 1, wherein the recipients are identified by their e-mail address or name.

8. The method of claim 1, wherein steps (i) and (ii) are performed in response to specifying one or more forward recipients by the user in the e-mail user agent.

9. The method of claim 1, wherein the steps (i) and (ii) are performed when the user commands the e-mail user agent to dispatch the forward e-mail.

10. The method of claim 1, wherein, if the e-mail has previously been sent or forwarded to other recipients prior to being sent to the user, steps (i) and (ii) are also carried out for said prior recipients.

11. The method of claim 1, wherein the e-mail user agent enables attributes for the forward recipients to be specified, wherein only the forward recipients with a certain attribute are included in step (i).

12. A method of forward filtering an email received by an email user agent and originally sent to one or more original recipients, the method being performed by the user agent in response to a user input to forward the email to at least one forward recipient, and comprising the steps of:
(i) comparing the forward recipient with the original recipients; and
(ii) if it is detected that the forward recipient matches one of the original recipients, the agent requesting the user to confirm that the e-mail is not to be forwarded to the matching forward recipient and, according to the user confirmation, causing the e-mail not to be forwarded to the matching forward recipient.

13. The method of claim 12, wherein, if the e-mail is to be forwarded to more than one forward recipient, steps (i) and (ii) are carried out for each of the forward recipients, and the forward e-mail is at least forwarded to the non-matching forward recipients.

14. The method of claim 12, wherein, if the e-mail is forwarded to more than one forward recipient and more than one forward recipient matches the original recipients, the step (ii) is performed for each matching forward recipient individually with an individual user interaction for each, or for all matching forward recipients once with one single user interaction.

15. The method of claim 12, wherein the e-mail can be amended by the user and wherein amending comprises at least one of (i) changing the content of the original e-mail, and (ii) adding content.

16. The method of claim 12, wherein, if the e-mail has been amended by the user, the agent causes the e-mail to be forwarded to the forward recipient, even if it is a matching forward recipient, without requiring a user confirmation therefor.

17. The method of claim 12, wherein the recipients are identified by their e-mail address or name.

18. The method of claim 12, wherein steps (i) and (ii) are performed in response to specifying one or more forward recipients by the user in the e-mail user agent.

19. The method of claim 12, wherein the steps (i) and (ii) are performed when the user commands the e-mail user agent to dispatch the forward e-mail.

20. The method of claim 12, wherein, if the e-mail has previously been sent or forwarded to other recipients prior to being sent to the user, steps (i) and (ii) are also carried out for said prior recipients.

21. The method of claim 12, wherein the e-mail user agent enables attributes for the forward recipients to be specified, wherein only the forward recipients with a certain attribute are included in step (i).

22. A method of e-mail forward filtering, performed by an e-mail server in response to a receipt, from a user, of an e-mail to be sent to recipients of a mailing list, the method comprising the steps of:
(i) ascertaining whether the e-mail is a forward e-mail including information for identifying the e-mail's original recipients;
(ii) comparing the recipients of the mailing list with the original recipients; and
(iii) if it is detected that one of the recipients of the mailing list matches one of the original recipients, the e-mail server causing the e-mail not to be sent to the matching recipient.

23. The method of claim 22, wherein, if the e-mail server causes the e-mail not to be sent to the matching recipient, it returns a message to the user indicating that the e-mail was not sent to the matching recipient.

24. A computer comprising a component for receiving and sending e-mails, said e-mail component is arranged to filter a forward e-mail in response to a user input to forward an original e-mail received by the e-mail user agent to at least one forward recipient, wherein the original e-mail was sent to one or more original recipients,
the e-mail component is arranged to compare the forward recipient with the original recipients, and
the e-mail component is arranged, in response to a match between the forward recipient and one of the original recipients, to perform at least one of:
(a) to request the user to confirm that the original e-mail is not to be forwarded to the matching forward recipient and, according to the user confirmation, to cause the original e-mail not to be forwarded to the matching forward recipient; or
(b) to cause the original e-mail not to be forwarded to the matching forward recipient without user confirmation.

25. A computer including an e-mail user agent arranged to enable a user to generate a forward e-mail in order to forward an original e-mail received by the e-mail user agent to at least one forward recipient, wherein the original e-mail was sent to one or more original recipients, comprising:
means for filtering the forward e-mail in response to a user input, comprising:
(i) means for comparing the forward recipient with the original recipients; and
(ii) means for causing the original e-mail not to be forwarded to the matching forward recipient if the comparing means detect that the forward recipient matches one of the original recipients.

26. The computer of claim 25, wherein the means (ii) comprise means for requesting the user to confirm that the original e-mail is not to be forwarded to the matching forward recipient and, only in accordance with the user confirmation, causing the original e-mail not to be forwarded to the matching forward recipient.

27. A computer program product including program code for execution on a computer comprising an e-mail user agent for filtering an email received by the agent and originally sent to one or more original recipients, said agent being arranged to, in response to a user input to forward the email to at least one forward recipient,
(i) compare the forward recipient with the original recipients; and
(ii) cause the e-mail not to be forwarded to the matching forward recipient if the agent detects that the forward recipient matches one of the original recipients.

28. The computer program product of claim 27, wherein said agent is arranged to request the user to confirm that the e-mail is not to be forwarded to the matching forward recipient and, only in accordance with the user confirmation, causes the e-mail not to be forwarded to the matching forward recipient.

29. A plug-in for providing an e-mail user agent with an e-mail forward filter functionality, said e-mail user agent being arranged to enable a user to generate a forward e-mail in order to forward an e-mail received by the e-mail user agent to at least one forward recipient, wherein the original e-mail was sent to one or more original recipients, the plug-in, when executed,
(i) compares the forward recipient with the original recipients; and
(ii) causes the original e-mail not to be forwarded to the matching forward recipient if the agent detects that the forward recipient matches one of the original recipients.

30. The plug-in of claim 29, arranged to requests the user to confirm that the original e-mail is not to be forwarded to the matching forward recipient and, only in accordance with the user confirmation, causes the original e-mail not to be forwarded to the matching forward recipient.

31. A computer including an e-mail user agent arranged to enable a user to generate a forward e-mail in order to forward an original e-mail received by the e-mail user agent to at least one forward recipient, wherein the original e-mail was sent to one or more original recipients, comprising:
a filter for the forward e-mail in response to a user input, comprising:
(i) a comparator for comparing the forward recipient with the original recipients; and
(ii) circuitry for preventing forwarding of the original e-mail to a matching forward recipient in response to the comparator detecting that the forward recipient matches one of the original recipients.

32. The computer of claim 31, wherein the circuitry is arranged for requesting the user to confirm that the original e-mail is not to be forwarded to the matching forward recipient and, only in accordance with the user confirmation, preventing forwarding of the original e-mail not to be forwarded to the matching forward recipient.

33. A plug-in for providing an e-mail user agent with an e-mail forward filter functionality, said e-mail user agent being arranged to enable a user to generate a forward e-mail in order to forward an e-mail received by the e-mail user agent to at least one forward recipient, wherein the original e-mail was sent to one or more original recipients, the plug-in, when executed, being arranged for:
(i) comparing the forward recipient with the original recipients; and
(ii) preventing forwarding of the original e-mail to the matching forward recipient in response to the agent detecting that the forward recipient matches one of the original recipients.

34. The plug-in of claim 33, arranged to (a) request the user to confirm that the original e-mail is not to be forwarded to the matching forward recipient and (b) prevent forwarding of the original e-mail to the matching forward recipient only in accordance with the user confirmation.
